(19) United States
(12) Patent Application Publication
(10) Pub. No.: US 2026/0230841 A1
(43) Pub. Date: Aug. 6, 2026

(54) A METHOD FOR CONTROLLING A COVER ENHANCING DEVICE CONTROLLING NODE, A METHOD FOR CONTROLLING A COVERAGE ENHANCING DEVICE, A COVERAGE ENHANCING DEVICE CONTROLLING NODE, AND A COVERAGE ENHANCING DEVICE

(71) Applicant: Sony Group Corporation, Tokyo (JP)

(72) Inventors: Olof ZANDER, Södra Sandby (SE); Erik BENGTSSON, Eslöv (SE); Fredrik RUSEK, Eslöv (SE); Jose FLORDELIS, Lund (SE); Zhinong YING, Lund (SE); Kun ZHAO, Malmö (SE); Johan HILL, Lund (SE)

(21) Appl. No.: 19/159,176

(22) PCT Filed: Jan. 31, 2024
(86) PCT No.: PCT/EP2024/052435

§ 371 Date: Aug. 22, 2025

(30) Foreign Application Priority Data
Mar. 3, 2023 (SE) 2350246-1

(51) Int. Cl. H04W 16/26; H04L 5/00; H04W 8/22; H04W 24/10

(52) U.S. Cl. CPC H04W 16/26; H04L 5/0051; H04W 8/22; H04W 24/10

(57) ABSTRACT

A method, performed in a coverage enhancing device, CED, controlling node for enabling determination of a relative angle between a coverage enhancing device, CED, and a wireless device. The method comprises initiating a first measurement of a first reference signal received via a first beam of the CED, the first beam having a first center of origin, COO. The method comprises initiating a second measurement of a second reference signal received via a second beam of the CED, the second beam having a second COO. The method comprises obtaining measurement data associated with the first measurement and the second measurement for enabling determination of a relative angle between the coverage enhancing device and the wireless device.

The present disclosure pertains to the field of wireless communications and positioning. The present disclosure relates to a method for controlling a coverage enhancing device (CED) controlling node, a method for controlling a coverage enhancing device (CED), a related CED controlling node and a CED.

### BACKGROUND

Today positioning of user equipment, UE, is an important part of wireless communications. The positioning of UEs has an impact on the quality and availability of telecommunication services. In cellular networks, the positioning of UEs is for example used to calculate the location of the device, which may then be used for various applications such as emergency services, navigation, tracking, and location-based advertising. Positioning of UEs may also be used for beam management of network nodes, such as base stations, CEDs, and/or UEs. Today, the positioning of the UE may be performed by using methods such as GPS, trilateration, cellular network, ultra-wideband, UWB, and/or Wi-Fi hotspot positioning.

The positioning of UEs can also have an impact on network performance. For example, if a large number of UEs are located in a specific area, it can cause network congestion, which can result in reduced network performance, connection quality, and call quality. As a result, the positioning of UEs is important to provide optimal network performance.

Nevertheless, positioning of UEs remains challenging and requires large amount of resources.

### SUMMARY

Approaches for positioning use hierarchical codebooks to find the UE direction and location. However, these approaches involve substantial overhead to perform tracking of a UE.

Other approaches for positioning use multiple reconfigurable intelligent surfaces, RIS, (or coverage enhancement devices, CEDs) to find a direction and position of a UE using the triangulation principle. An RIS can actively customize a radio environment by adjusting the phase shift independently of incident signals. However, the controlling of such multiple RIS results in the use of more resources.

Accordingly, there is a need for devices and methods for controlling a coverage enhancing device controlling node, which may mitigate, alleviate or address the shortcomings existing and may provide a low resource positioning of UEs.

A method is disclosed, performed in a coverage enhancing device, CED, controlling node for enabling determination of a relative angle between a coverage enhancing device, CED, and a wireless device. The method comprises initiating a first measurement of a first reference signal received via a first beam of the CED, the first beam having a first center of origin, COO. The method comprises initiating a second measurement of a second reference signal received via a second beam of the CED, the second beam having a second COO. The method comprises obtaining measurement data associated with the first measurement and the second measurement for enabling determination of a relative angle between the coverage enhancing device and the wireless device.

Further, a CED controlling node is provided, the CED controlling node comprising memory circuitry, processor circuitry, and a wireless interface, wherein the CED controlling node is configured to perform any of the methods disclosed herein and relating to the CED controlling node.

It is an advantage of the present disclosure that the CED controlling node can configure the CED to retransmit one or more reference signals with different beams having different centers of origin, COOs, which in turn allows the determination of an angle between the CED and a wireless device (WD), such as a UE. It may be appreciated that the beams have different COOs but may have substantially identical spatial direction and beam shape. In other words, by configuring the CED to retransmit reference signals with different beams having different separated COOs, such as from different antenna elements being separated by a distance, it is possible to determine an angle between the CED and a wireless device. It may be appreciated that the present disclosure may allow more efficient and accurate positioning of wireless devices, such as UEs, by determining an angle between the CED and a wireless device. It may be appreciated that the present disclosure improves beamforming management. For example, the determination of the angle between the CED and WD may allow to improve the beamforming of the communication system, such as beamforming of the CED and/or a radio network node. It is therefore an advantage of the present disclosure to save resources. The present disclosure improves the estimation of the angle between the CED and WD.

A method is disclosed, performed in a (such as by a) coverage enhancing device, CED, for enabling determination of a relative angle between the coverage enhancing device and a wireless device. The method comprises receiving a first initiating message indicative of a first beam and using a first subset of a plurality of antenna elements of the CED having a first COO for enabling a first measurement of a first reference signal. The method comprises receiving a second initiating message indicative of a second beam and using a second subset of a plurality of antenna elements of the CED having a second COO for enabling a second measurement of a second reference signal. The method comprises performing, based on the first initiating message and the second initiating message, a channel measurement procedure for enabling determination of a relative angle between the CED and the WD, using the first beam and the second beam.

Further, a CED is provided, the CED comprising memory circuitry, processor circuitry, and a wireless interface, wherein the CED is configured to perform any of the methods disclosed herein and relating to the CED.

It is an advantage of the present disclosure that the CED controlling node can be configured by the CED controlling node to retransmit one or more reference signals with different beams having different centers of origin, COOs, which in turn allows the determination of an angle between the CED and a wireless device, such as a UE. In other words, by having a CED that can be configured to retransmit reference signal with different beams having different separated COOs, such as from different antenna elements being separated by a distance, it is possible to determine an angle between the CED and a wireless device. It may be appreciated that the present disclosure may allow more efficient and accurate positioning of wireless devices, such as UEs, by determining an angle between the CED and a wireless device.

It may be appreciated that the determination of the angle between the CED and WD may allow improved beamforming of the communication system, such as beamforming of the CED and/or a radio network node. It is therefore an advantage of the present disclosure to save resources.

An advantage of the present disclosure is that an angle can be determined at a low resource cost compared to existing methods and that a CED aided system can use the present disclosure in a wireless communication system, such as a 3GPP system.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node, an example CED, and an example wireless device according to this disclosure,

FIGS. 2A-2B show a flow-chart illustrating an example method, performed in a CED controlling node, for controlling the CED according to this disclosure,

FIGS. 3A-3B show a flow-chart illustrating an example method, performed in a CED, according to this disclosure,

FIGS. 4A-4B are diagrams illustrating an example scenario where an example technique as disclosed herein is applied,

FIG. 5A is a diagram illustrating an example scenario where an example method according to this disclosure is applied,

FIG. 5B is a diagram illustrating an example scenario where an example method according to this disclosure is used in comparison to an angle estimation using a single beam with a single COO,

FIG. 6 is a diagram illustrating examples of different CED configurations according to this disclosure,

FIG. 7 is a block diagram illustrating an example CED controlling node according to this disclosure,

FIG. 8 is a block diagram illustrating an example CED according to this disclosure,

FIG. 9 is a signaling diagram illustrating an example embodiment according to this disclosure,

FIG. 10 is a diagram illustrating an example CED according to this disclosure, and

FIG. 11 is a diagram illustrating an example scenario where an example method according to this disclosure is applied.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

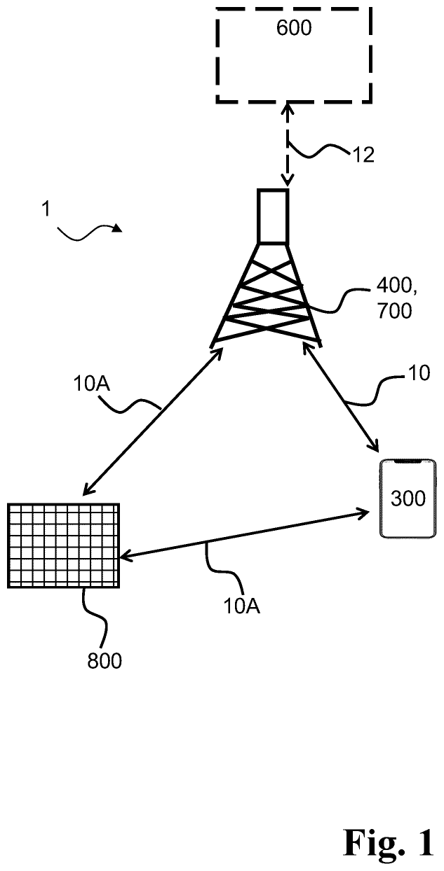

FIG. 1 is a diagram illustrating an example wireless communication system 1 according to this disclosure. The wireless communication system 1 comprises a wireless device 300, a network node 400 and a core network (CN) node 600.

As discussed in detail herein, the present disclosure relates to a wireless communication system 1 comprising a cellular system, for example, a 3GPP wireless communication system.

A network node disclosed herein refers to a radio access network (RAN) node operating in the radio access network, such as a base station, an evolved Node B, eNBs, a global Node B, gNBs in NR, and/or a transmission and reception point (TRP). In one or more examples, the RAN node is a functional unit which may be distributed in several physical units.

A CN node disclosed herein refers to a network node operating in the core network, such as in the Evolved Packet Core Network, EPC, and/or a 5G Core Network, 5GC. Examples of CN nodes in EPC include a Mobility Management Entity, MME.

In one or more examples, the CN node is a functional unit which may be distributed in several physical units.

The wireless communication system 1 described herein may comprise one or more wireless devices 300, and/or one or more network nodes 400, such as one or more of: a base station, an eNB, a global Node B, gNB, and/or an access point.

A wireless device may refer to as a mobile device and/or a user equipment, UE.

The wireless device 300 may be configured to communication with the network node 400 via a wireless link (or radio access link) 10, 10A.

The wireless communication system 1 may comprise a coverage enhancing device (CED) 800. The CED 800 may be one or more of a smart repeater, a reflective intelligent surface (RIS), a network controlled repeater (NCR), and/or another wireless device (WD). The CED 800 may provide coverage enhancement for devices using 5G and beyond. The CED 800 may be configurable by the network node 400 and/or the CN node 600, and may be used to improve signal coverage in the wireless communication system 1. The CED 800 may be used to retransmit, such as forward, signals, such as data and/or control signals, between the network node 400 and the WD 300. The retransmission can be advantageous when the WD 300 is located at hard-to-reach locations, such as at a border of a coverage area of the network node 400 and/or when a direct link between the network node 400 and the WD 300 is obstructed. It may be appreciated that the CED 800 can also be used to increase the multiple components and/or channel rank to support MIMO communication between the network node 400 and the WD 300, even in a well-covered area. The CED 800 may comprise a plurality of antenna elements that can be configured with a respective phase shift. By controlling the phase shifts, such as jointly controlling the phase shifts, an incoming and/or outgoing angle of a signal received and/or transmitted by the CED 800 can be controlled and/or adapted. In one or more example methods, the angle of incoming and outgoing signals can be controlled by controlling the relative phase between antenna elements of the CED 800. The phase shift may be a capacitor-based phase shift and/or a true time delay line, such as a time domain shift, between antenna elements of the CED 800. The WD 300 may be configured to communicate with the network node 400 directly via the wireless link (or radio access link) 10 and/or via the CED 800 via wireless link 10A. The wireless link 10A may herein be referred to as a reflected, such as retransmitted, wireless link. The CED 800 may be controlled by one or more network nodes, such as the network node 400, or one or more wireless devices, such as the WD 300. In one or more example embodiments or examples, the network node 400 may be seen as the CED controlling node, such as CED controlling node 700. The one or more network nodes or wireless devices controlling the CED 800 may herein be referred to as coverage enhancing device controlling nodes. In one or more example methods, the coverage enhancing device controlling node can be a CN node, such as the CN node 600 in FIG. 1. In one or more example methods, the coverage enhancing device controlling node can be a node in an external network that can access the CED 800, for example through the internet via a gateway function. In one or more example examples or embodiments, the CED 800 as disclosed herein may be configured with separate codebooks (CB) associated with each COO. The CED 800 may thereby be configured to change COO based on a current configuration. It may be appreciated that in some embodiments or examples, a beam ID for each CB may be the same to minimize signaling. In one or more example methods, a beam ID may be seen as a number indicative of the position in the CB of a beam, such as an identification used to separate beams from each other. In other words, the codebooks for different COOs may be harmonized so that the same entry of codebooks corresponding to different COOs point in the same spatial directions. For example, by indicating that the beam of a new CB should be used which corresponds to the current beam of the current CB. For example, the CED may be configured to change COO but keep the beam, such as keeping the same phase pattern. In other words, the CED may be configured to keep the same beam configuration parameters and use them for a new beam with a different COO. For example, the CED may be configured to keep the same beam parameters, but generate the beam at different subsets of antenna elements in order to move the COO of the beam.

A difference between a RIS and an NCR may be that a RIS has a single array while an NCR has separate arrays toward the radio network node, such as gNB, and the UE. This may have the consequence that, for a RIS, a measured phase difference for two COOs may depend on both an angle towards the gNB and an angle towards the UE, while for an NCR a measured phase only depends on an angle towards the UE. Therefore, for the RIS case, assuming both the radio network node, such as gNB, and the CED are static, a calibration may be needed to determine an angle towards the UE. It may be appreciated that the angle towards the UE is an estimated angle, and that calibration may be needed in order to improve the beam coverage towards the UE. In one or more example embodiments, the angle from the CED to the network node can either be assumed to be known or not. For example, when the angle is assumed to be known, then only the angle toward the WD may be determined. For example, when the angle is assumed not to be known, then both angles may be determined. It may be appreciated that measurements may be obtained differently for a RIS and an NCR. In one or more example embodiments, both an RIS and an NCR would need calibration.

According to the current disclosure, the CED 800 can be configured, for example by a CED controlling node, to perform and/or participate in a channel measurement procedure for enabling determination of an angle, such as a relative angle, between the CED 800 and the WD 300. The CED controlling node can be the WD 300 or the radio network node 400. A relative angle as disclosed herein may be seen as an angle relative to an angle of a current beam configuration.

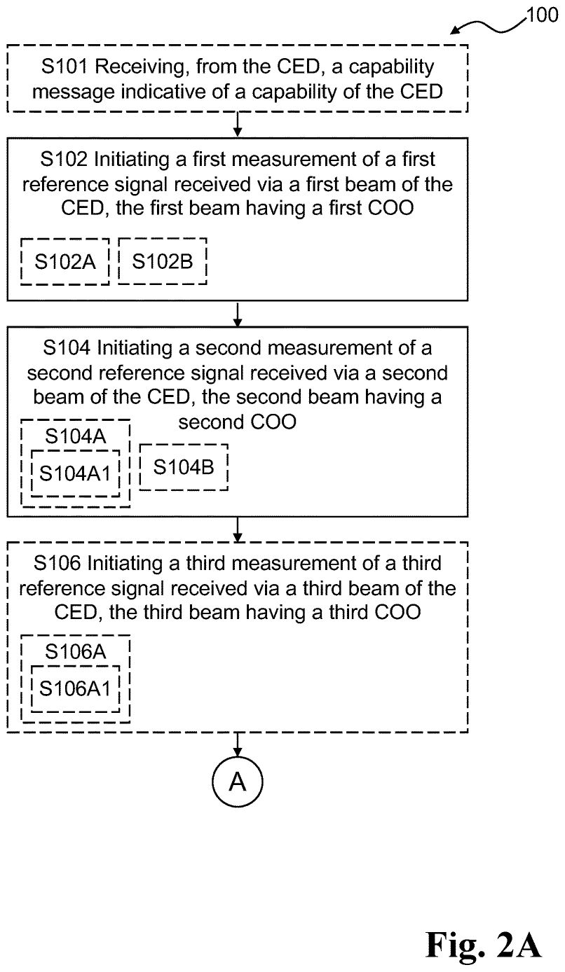

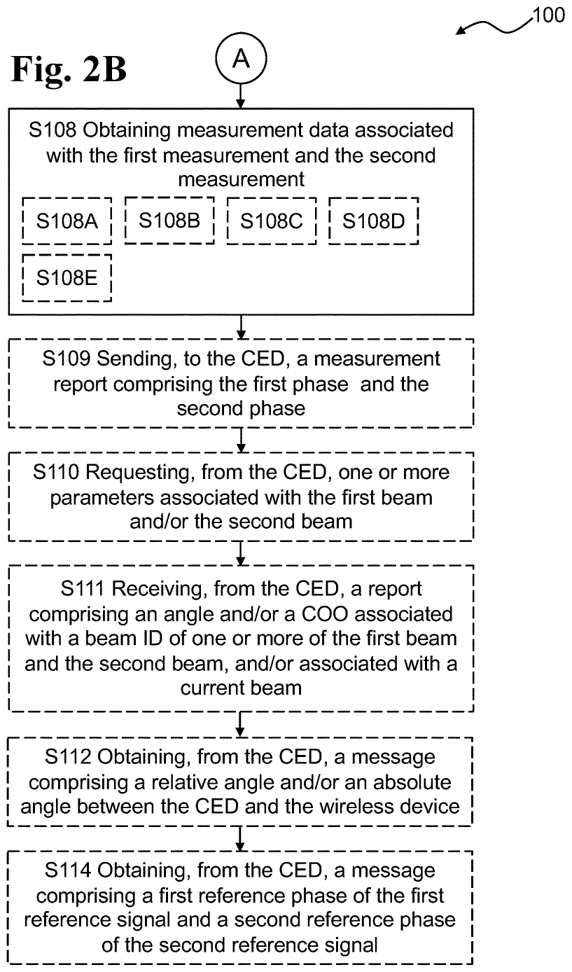

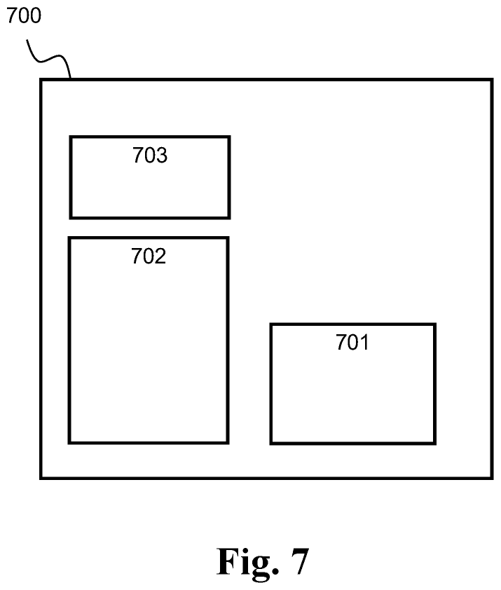

FIG. 2A-2B shows a flow diagram of an example method 100, performed by a coverage enhancing device, CED, controlling node. The method may be a method for enabling determination of an angle, such as a relative angle, between a coverage enhancing device, CED, and a wireless device, WD. In other words, the method may be for enabling positioning of a wireless device, such as WD 300. The method may be seen as for enabling angle estimation by multiple point of origin (AE-MPO). It may be appreciated that the method may be for optimizing a beamforming of a CED, such as CED 800. The CED controlling node is the CED controlling node disclosed herein, such as the network node 400 and/or the wireless device 300 of FIG. 1, and/or the CED controlling node 700 of FIG. 7. The present method(s) as disclosed herein, may be used with multiple antenna arrays, multiple solitary antennas, and/or with single antenna array, which may be configured such that a part of the array area may be used at the time. For example, when a single antenna array is used and subsets of antenna elements of the array are configured with beams, the rest of the array may be turned off or directed in a different direction that does not interfere with the measurement.

The method 100 comprises initiating S102 a first measurement of a first reference signal received via a first beam of the CED. The first beam has a first center of origin, COO.

Initiating S102 a first measurement may comprise initiating a first channel sounding by a wireless device, such as wireless device 300, via the first beam of the CED having the first COO.

A COO as disclosed herein may be seen as a phase center of a beam formed by a CED.

A CED, such as CED 800, may comprise a plurality of antenna elements. A beam, such as the first beam, may be formed by the CED using a subset, such as a first subset, of the plurality of antenna elements. A COO of a beam may be seen as a COO of a subset of a plurality of antenna elements of the CED where the subset forms the beam.

The method 100 comprises initiating S104 a second measurement of a second reference signal received via a second beam of the CED. The second beam has a second COO.

Initiating S104 a second measurement may comprise initiating a second channel sounding by a wireless device, such as wireless device 300, via the second beam of the CED having the first COO. The second beam may be formed by the CED using a second subset of the plurality of antenna elements.

A measurement as disclosed herein, such as the first measurement, the second measurement, and/or the third measurement, may be seen as a measurement of an angle and/or a phase toward the WD 300 with respect to a COO of a beam at the CED. In other words, a measurement as disclosed herein may be seen as a measurement of a relative angle and/or a phase toward the WD 300 from the center of an antenna array of the CED. Formulated differently, a measurement as disclosed herein may be seen as a measurement of an angle and/or a phase from a COO of the CED to a transmission or receiving point in the far field, FF. The first measurement may be indicative of a first angle and/or a phase between the first COO and the WD, such as WD 300. The second measurement may be indicative of a second angle and/or a phase between the second COO and the WD, such as WD 300.

In one or more example methods, when the signal, such as the first reference signal and/or the second reference signal, is transmitted in an Uplink (UL), the transmitter node is a WD, such as the WD 300, and the receiver node is a radio network node, such as the radio network node 400. In one or more example methods, when the signal, such as the first reference signal and/or the second reference signal, is transmitted in a Downlink (DL), the transmitter node is a radio network node, such as the radio network node 400, and the receiver node is a WD, such as the WD 300. In one or more example methods, the first reference signal and the second reference signal may be the same signal in the UL scenario. In other words, the same reference signal may be received at the CED via the first beam having the first COO and via the second beam having the second COO. Formulated differently, the same reference signal may be received by the CED at the first subset of antenna elements and at the second subset of antenna elements. It may be appreciated that for the UL scenario only a single resource may be required for UL-based angle estimation. In one or more example methods, the signal, such as first reference signal and/or second reference signal, is transmitted in a Sidelink scenario, where the WD transmits the signal to another WD, such as UE. For example, the WD may transmit the signal to another WD via the CED.

In one or more example methods, the first reference signal and the second reference signal may be different signals, e.g., in the DL scenario. In other words, the first reference signal from the network node 400 may be received at the CED via the first beam having the first COO and the second reference signal from the network node 400 via the second beam having the second COO. In one or more example methods, the first reference signal and the second reference signal are different signals transmitted/received at different times. It may be appreciated that for the DL scenario a single resource per COO may be required for DL-based angle estimation.

In one or more example methods, the second COO is different from the first COO. In other words, the first COO and the second COO may be separated by a distance, d, from each other. A CED as disclosed herein may comprise one or more antenna arrays. In one or more example methods, a CED as disclosed herein may comprise one or more antenna arrays comprising separate antenna units, such as two separate antenna units, a first antenna unit and a second antenna unit. For example, the first COO may be comprised in the first antenna unit, such as first antenna array, and the second COO in the second antenna unit, such as second antenna array. In one or more example methods, the CED as disclosed herein may comprise a single array, such as in the same antenna unit, configured with beams with different COOs. For example, the first COO and the second COO may be comprised in the same antenna array. In one or more example methods, the CED as disclosed herein may comprise one antenna array per beam and COO set. In other words, the CED may be configured with a plurality of antenna arrays each having an associated beam and COO.

The method 100 comprises obtaining S108 measurement data associated with the first measurement and the second measurement at the CED, such as CED 800, and the WD, such as WD 300, for enabling determination of a relative angle between the CED 800 and the WD 300. Obtaining S108 measurement data may comprise receiving, retrieving, and/or determining measurement data. Obtaining S108 measurement data may comprise obtaining measurement data from the CED (such as CED 800), the WD (such as WD 300), and/or the CN node (such as CN node 600). In other words, obtaining S108 measurement data may comprise determining a relative angle between the CED and the WD based on the measurement data. Based on, as described herein, may be seen as “a function of” and/or “used as an input to”. For example, the relative angle between the CED and the WD may be a function of the measurement data and/or the measurement data may be used as an input to determine the relative angle. The determination of the relative angle may comprise determining a phase difference between the first measurement and the second measurement.

Measurement data as disclosed herein may be seen as data indicative of and/or comprising a measurement as disclosed herein, such as the first measurement, the second measurement, and/or the third measurement. Measurement data may be seen as data indicative of and/or comprising a measurement of an angle and/or a phase toward the WD 300 with respect to a COO of a beam at the CED. In one or more example methods, the measurement data comprises information relative to the positions of the COOs, such as the position of the first COO and the second COO.

In other words, measurement data as disclosed herein may be seen as and/or comprise one or more measurements of relative angles and/or phases toward the WD 300 from one or more centers of antenna arrays of the CED. Formulated differently, measurement data as disclosed herein may be seen as and/or comprise measurements of angles and/or phases from one or more COOs of the CED to a transmission or receiving point in the far field, FF. The measurement data may be indicative of and/or comprise one or more angles and/or phases between the COOs of the CED, such as CED 800, and the WD, such as WD 300. In one or more example methods, calibration may be needed as the propagation path between the CED 800 and the network node 400 (which may be assumed static) may generate a static phase offset. For example, a calibration of the obtained phases may be performed, e.g., to compensate for a difference between the CED 800 and the network node 400. In other words, when a phase difference between the CED 800 and the network 400 is substantially static, this difference may be compensated for by calibrating a phase measurement.

In one or more example methods, initiating S102 the first measurement comprises sending S102A, to the CED (such as CED 800), a first configuration for configuring the CED with the first beam having the first COO. In other words, initiating S102 the first measurement may comprise sending a first configuration message to the CED, the first configuration message comprising information and/or settings associated with the first configuration. A configuration as disclosed herein, such as the first configuration, the second configuration, and the third configuration, may be seen as information and/or settings indicative of a configuration of a beam and/or a COO of the CED. By sending a configuration to the CED, the CED controlling node may indicate to the CED which configuration of beam(s) and/or COO(s) to use/adopt. A configuration may indicate to the CED which antenna array to use (such as which subset of antenna elements to use), which beam to use, and/or which COO to use for retransmitting a signal.

In one or more example methods, a configuration may be determined at the CED controlling node. In one or more example methods, a configuration may be based on a capability of the CED. A configuration may be determined at the CED controlling node based on a capability of the CED, such as based on a prior knowledge of a capability of the CED.

In one or more example methods, initiating S102 the first measurement comprises sending S102B, to the wireless device, a first request message configuring the WD to transmit and/or receive the first reference signal. The WD may be configured to transmit the first reference signal in an UL scenario and/or to receive the first reference signal in an DL scenario. In other words, sending S102B the first request message comprises requesting the WD to transmit and/or receive the first reference signal. For example, the first request message may configure the WD to perform a first channel sounding by transmitting and/or receiving the first reference signal.

A channel sounding as disclosed herein may comprise an UL pilot transmission, such as sounding reference signals, SRS, positioning reference signals, PRS, and/or phase tracking reference signals, PTRS. A channel sounding as disclosed herein may comprise an DL pilot, such as channel state information reference signals, CSI-RS, and/or pilot transmission signals, PTRS. A pilot transmission may comprise an associated reporting of a measured phase. A channel sounding as disclosed herein may comprise for DL a synchronization signal block, SSB.

In one or more example methods, initiating S104 the second measurement comprises sending S104A, to the CED (such as CED 800), a second configuration configuring the CED with the second beam having the second COO. In other words, initiating S104 the second measurement may comprise sending a second configuration message to the CED, the second configuration message comprising information and/or settings associated with the second configuration.

In one or more example methods, initiating S104 the second measurement comprises sending S104B, to the wireless device, a second request message configuring the WD to transmit and/or receive the second reference signal. The WD may be configured to transmit the second reference signal in an UL scenario and/or to receive the second reference signal in a DL scenario. In other words, sending S104B the second request message comprises requesting the WD to transmit and/or receive the second reference signal. For example, the second request message may configure the WD to perform a second channel sounding by transmitting and/or receiving the second reference signal.

In one or more example methods, the method 100 comprises receiving S101, from the CED, a capability message indicative of a capability of the CED, wherein the capability comprises one or more COO configurations of the CED. In one or more example methods, the method 100 comprises prior to receiving the capability message sending a capability request message from the CED controlling node to the CED. A capability message as disclosed herein may be seen as a message comprising information about a capability of a CED. For example, a capability message may comprise information about one or more COO configurations of the CED, such as one or more positions of the COOs of the CED. For example, in order to enable determination of an angle between the CED and the WD, the network, such as the CED CN, the network node, and/or the CN node, may require information from the CED about whether a feature is supported or not by the CED. For example, a capability message may indicate whether the CED is capable of performing measurements on the UL signals transmitted by the WD.

A configuration signal of the CED to change to a configuration associated with a predetermined COO associated with dedicated time resources. In other words, the CED CN may be configured to configure the CED to use two different COOs with beams pointing in substantially the same spatial direction. Further, the CED CN may be configured to indicate time slots when the CED should apply these configurations.

In one or more example methods, wherein the capability comprises one or more of: a capability of changing COO for a number K of beams, a capability of measuring phase and/or amplitude of dedicated resources, a relative position of the COO for each beam, a number of available COOs, one or more angles associated with one or more beams, a dimensionality of the CED, a position of the CED, an orientation of the CED, and whether there is a dependency between an input angle and an output angle.

A capability of changing COO for a number K of beams may be seen as a capability of a CED to change COO for a number K of available beams at the CED. For example, a capability may indicate whether the CED has dedicated codebooks with different COOs and the relations between the COOs.

A capability of measuring phase and/or amplitude of dedicated resources may be seen as a capability of a CED to measure the phase and/or amplitude of a reference signal which is received using a certain beam with a certain COO on designated frequency-time resources.

A relative position of a COO for each beam may be seen as a relative position of a COO for each available and/or used beam at the CED. A relative position of a COO for a beam may be seen as a relative position of a COO with respect to the other COOs of the CED. In one or more example methods, the COOs of the CED are predefined. For example, for an active CED the COO may be the center of the Tx/Rx unit. For a passive CED, the COO may be the location of the reflection phase center. A relative position of the COO for each beam may allow to determine the distance between the first COO and the second COO.

An angle associated with a beam may indicate a directionality of the beam, such as a main direction of the beam. For example, for a pencil beam, an angle associated with a beam may indicate a strong directionality of the beam. In other words, a main direction of a beam may be relative to a local coordinate system.

A dimensionality of the CED may be seen as a geometrical configuration of the plurality of antenna elements of the CED, such as an antenna array configuration. For example, the CED may comprise a linear array (1D), a planar array (2D), a conformal array (2D surface), etc. A dimensionality may also be seen as a size of an array of the CED, such as the dimensions of an array of the CED.

A dependency between an input angle and an output angle may be seen as information on whether a combination of an incident angle and a re-directed angle is supported by the CED.

In one or more example methods, obtaining S108 measurement data comprises obtaining S108A a first phase associated with the first measurement and a second phase associated with the second measurement. In one or more example methods, the first phase and the second phase are obtained from the CED and/or the WD. In one or more example methods, obtaining S108A the first phase and the second phase comprises determining the first phase and the second phase based on the first measurement and the second measurement. In one or more example methods, obtaining S108A the first phase and the second phase comprises determining the first phase and the second phase based on the first measurement, the second measurement, and the capability of the CED. The first phase may be associated with the first reference signal, such as associated with the first beam, the first COO, and/or the first measurement. The second phase may be associated with the second reference signal, such as associated with the second beam, the second COO, and/or the second measurement.

In one or more example methods, obtaining S108 measurement data comprises determining S108B a first phase difference between the first phase and the second phase. Determining S108B the first phase difference may be seen as determining (such as measuring) a phase difference based on two beam configurations that differ in COO. It may be appreciated that an angle of arrival, AoA, and/or an angle of departure, AoD, may be determined based on a phase difference and a separation, d, between two COOs.

In one or more example methods, the method 100 comprises sending S109, to the CED, a measurement report comprising the first phase and the second phase. In one or more example methods, the CED controlling node is configured to send a measurement report to the CED in a DL scenario where the first reference signal and the second reference signal are transmitted from the radio network node 400, such as for a DL-based channel sounding. In one or more example methods, the CED controlling node is configured to send a measurement report to the CED when the CED cannot measure the first phase and the second phase in an UL scenario or in DL-based channel sounding. A measurement report may comprise absolute and/or relative phase (such as amplitude and/or part of the wavelength) values associated with different measurements, such as different COO measurements. The absolute and/or relative phase may be used to determine the angle towards the WD 300, such as transmitting or receiving point in the far field.

In one or more example methods, obtaining S108 measurement data comprises determining S108C, based on the first phase difference, the first COO, the second COO, and/or a difference between the first COO and the second COO, the relative angle. In one or more example methods, the determination S108C of the relative angle may be based on the relative positions of the COOs, such as relative positions of the first COO and the second COO.

In one or more example methods, the method 100 comprises requesting S110, from the CED, one or more parameters associated with the first beam and/or the second beam. The one or more parameters may comprise one or more of: a beam angle, a relative position of a COO, and an absolute position of a COO.

In one or more example methods, the method 100 comprises receiving S111, from the CED, a report comprising an angle, such as a beam angle, and/or a COO associated with a beam ID of one or more of the first beam and the second beam, and/or associated with a current beam. In one or more example methods, the report from the CED may be received in response to requesting S110 the one or more parameters. In one or more example methods, receiving S111 the report comprises receiving a message from the CED comprising the report.

It may be appreciated that the current beam may be the first beam or the second beam. A COO associated with a beam ID of one or more of the first beam and the second beam may comprise a position, such as a relative and/or absolute position, of the COO associated with a beam ID of one or more of the first beam and the second beam.

In one or more example methods, the method 100 comprises obtaining S112, from the CED, a message, such as a first message, comprising a relative angle and/or an absolute angle between the CED and the wireless device WD. In other words, the message may comprise information indicative of the relative angle and/or absolute angle. In one or more example methods, the relative angle and/or the absolute angle are determined, such as estimated, at the CED, then transmitted to the CED controlling node via the message which is received at the CED controlling node. In one or more example methods, the CED may be configured to transmit the message to the network, such as to the radio network node and/or a positioning node. The positioning node may be comprised in the CN node, such as CN node 600. In one or more example methods, the message from the CED may be received in response to the CED controlling node sending a request for the message, such as a request for an estimated relative phase and/or absolute phase, to the CED. In one or more example methods, the CED may use the determined relative angle and/or absolute angle internally for autonomous beam adjustment. In one or more example methods, the message may comprise a position and/or orientation of the CED, such as an NCR.

In one or more example methods, the method 100 comprises obtaining S114, from the CED, a message, such as a second message, comprising a first reference phase of the first reference signal and a second reference phase of the second reference signal. The first reference phase and the second reference phase may be absolute phases measured by the CED.

In other words, the message may comprise information indicative of the first reference phase and the second reference phase. In one or more example methods, the first reference phase and the second reference phase are determined, such as measured, at the CED, then transmitted to the CED controlling node via the message which is received at the CED controlling node. In one or more example methods, the CED may be configured to transmit the message to the network, such as to the radio network node and/or a positioning node. The positioning node may be comprised in the CN node, such as CN node 600. In one or more example methods, the message from the CED may be received in response to the CED controlling node sending a request for the message, such as a request for a measured absolute phase of the reference signals, to the CED. The first reference phase may be seen as a first phase of the first reference signal measured at the CED. The second reference phase may be seen as a second phase of the second reference signal measured at the CED.

In one or more example methods, the CED comprises a RIS scattering pattern.

In one or more example methods, sending S104A the second configuration comprises sending S104A1 instructions instructing the CED to apply a first phase pattern of the first beam to the second COO. In one or more examples, configuring the CED with the second beam comprises switching the first COO of the first beam to the second COO of the second beam. The first phase pattern of the first beam may be formed by a regular phase pattern having a pre-defined phase center location as the first COO. Applying a first phase pattern of the first beam to the second COO and switching the first COO of the first beam to the second COO of the second beam may be seen as copying a phase code book of the first beam and then shifting the first COO in a x1- and/or y1-direction with an X1 distance and/or an Y1 distance from the first COO, thereby applying a similar phase pattern as the first phase pattern in a new phase center, namely the second COO. The second beam may apply the same pattern as the first beam but applied to another subset of antennas.

In some examples, there may be two subsets of antennas, one for the first beam and one for the second beam, wherein the two subsets have the same cardinality. In some examples, there may exist a translation vector (deltaX, deltaY, deltaZ) so that for each antenna of the first subset, there is one antenna in the second subset which is positioned at (deltaX, deltaY, deltaZ) away from the corresponding antenna in the first subset.

In one or more example methods, the method 100 comprises initiating S106 a third measurement of a third reference signal received via a third beam of the CED. The third beam has a third COO. The third COO may be different from the first COO and the second COO.

Initiating S106 a third measurement may comprise initiating a third channel sounding by a wireless device, such as wireless device 300, via the third beam of the CED having the third COO. The third beam may be formed by the CED using a third subset of the plurality of antenna elements. In one or more example methods, the method 100 comprises initiating further measurements using further beams and COOs, such as a fourth beam having a fourth COO, a fifth beam using a fifth COO etc. In one or more example methods, the third COO is offset from the first COO and the second COO, such that the three COOs form a triangle without a right angle.

In one or more example methods, initiating S106 a third measurement comprises sending S106A, to the CED, a third configuration configuring the CED with the third beam having the third COO. In other words, initiating S106 the third measurement may comprise sending a third configuration message to the CED, the third configuration message comprising information and/or settings associated with the third configuration.

In one or more example methods, sending S106A the third configuration comprises sending S106A1 instructions instructing the CED to apply a first phase pattern of the first beam to the third COO and wherein configuring the CED with the third beam comprises switching the first COO of the first beam to the third COO of the third beam. Applying a first phase pattern of the first beam to the third COO and switching the first COO of the first beam to the third COO of the third beam may be seen as copying a phase code book of the first beam and then shifting the first COO in a x2- and/or y2-direction with an X2 distance and/or an Y2 distance from the first COO, thereby applying a similar phase pattern as the first phase pattern in a new phase center, namely the third COO. In one or more example methods, three states with three different phase center locations, such as COOs, have been formed. In other words, three beams, namely the first beam, the second beam, and the third beam having each a different COO, namely the first COO, the second COO, and the third COO have been formed.

In one or more example methods, obtaining S108 measurement data comprises obtaining S108D a third phase associated with the third measurement, such as a third phase associated with the third COO. It may be appreciated that by using these three states, three measurements of reference signals can be initiated for determining a location of the WD, such as WD 300, and/or for determining a moving vector associated with the WD.

In one or more example methods, obtaining S108 measurement data comprises determining S108E a second phase difference between the first phase and the third phase. Determining the first phase difference and the second phase difference may allow determining a position of the WD and/or a moving vector associated with the WD. It may be appreciated that by initiating three measurements, it may be possible to determine a three dimensional, 3D, location and a moving vector associated with the WD. By being able to control a CED, such as an RIS, to change COO by shifting a phase pattern and thereby form three beams with separate COOs it may be possible to use a triangle positioning principle for positioning of the WD.

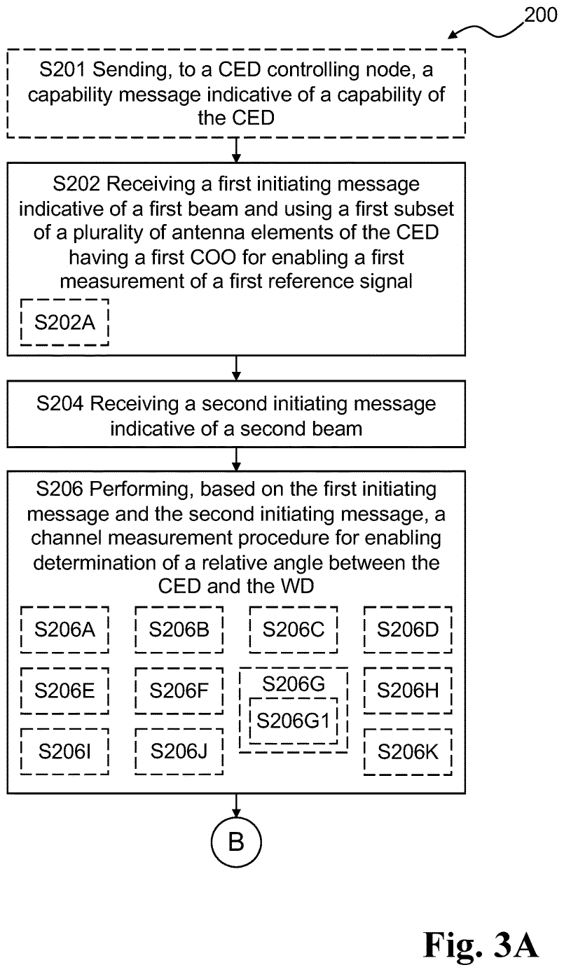

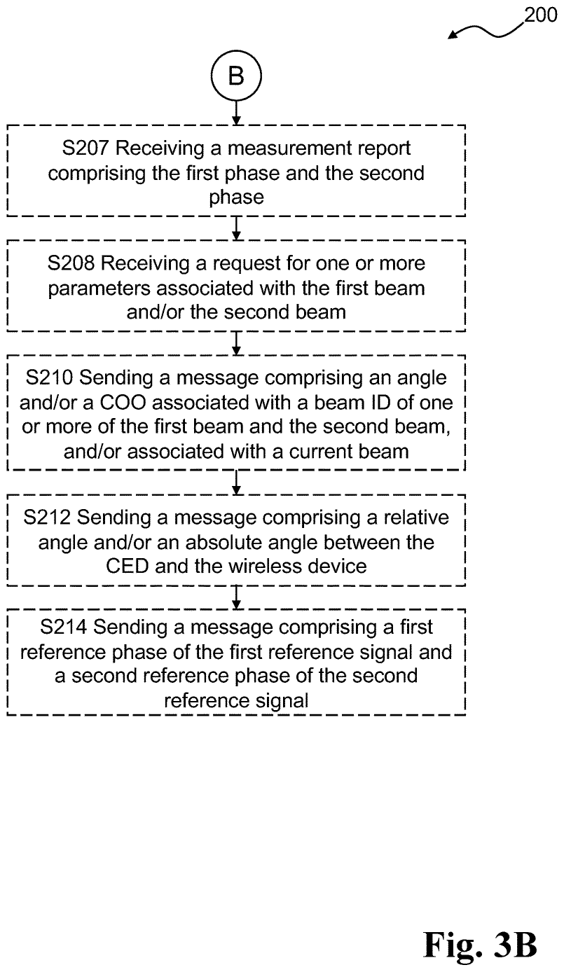

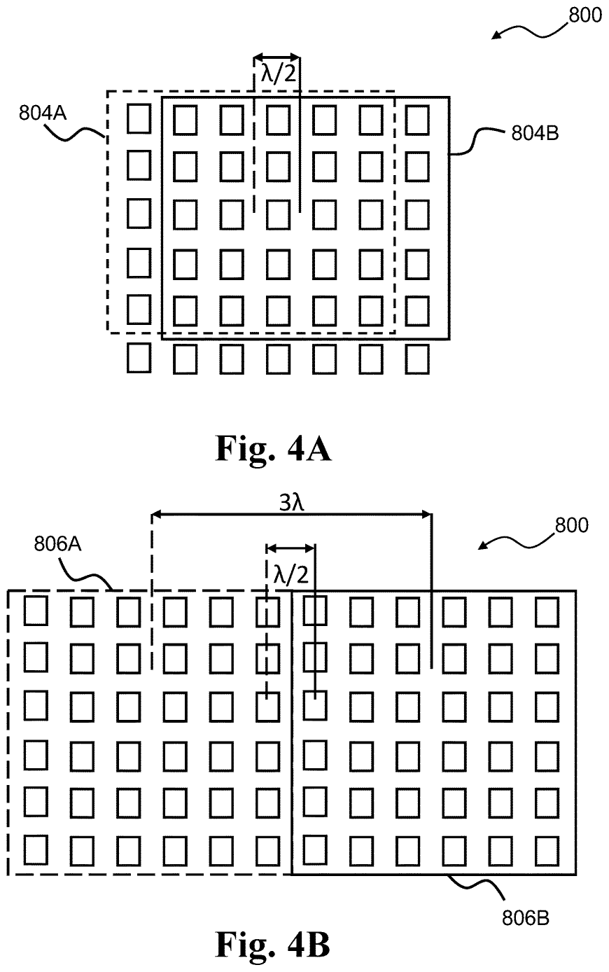

FIG. 3A-3B shows a flow diagram of an example method 200, performed by a coverage enhancing device, CED according to the disclosure. The method may be a method for enabling determination of an angle, such as a relative angle, between a coverage enhancing device, CED, and a wireless device, WD. In other words, the method may be for enabling positioning of a wireless device, such as WD 300. It may be appreciated that the method may be for optimizing a beamforming of a CED, such as CED 800. The CED is the CED as disclosed herein, such as the CED 800 of FIG. 1, FIGS. 4A-4B, FIGS. 5A-5B, FIG. 6, FIG. 8, FIG. 9, FIG. 10, FIG. 11.

The method 200 comprises receiving S202 a first initiating message indicative of a first beam and using a first subset of a plurality of antenna elements of the CED having a first COO for enabling a first measurement of a first reference signal.

The method 200 comprises receiving S204 a second initiating message indicative of a second beam and using a second subset of a plurality of antenna elements of the CED having a second COO for enabling a second measurement of a second reference signal.

In one or more example methods, an initiating message, such as the first initiating message and the second initiating message, may be indicative of and/or comprise a configuration for configuring the CED with a certain beam using a certain subset of a plurality of antenna elements having a certain COO.

The method 200 comprises performing S206, based on the first initiating message and the second initiating message, a channel measurement procedure for enabling determination of a relative angle between the CED and the WD, using the first beam and the second beam. Performing S206 a channel measurement procedure may be seen as participating in a channel measurement procedure. A channel measurement procedure may be performed in UL and DL. A channel measurement procedure as disclosed herein may comprise performing and/or participating in the first measurement, the second measurement, and optionally in the third measurement.

In one or more example methods, the method 200 comprises sending S201, to a CED controlling node, a capability message indicative of a capability of the CED.

In one or more example methods, the capability comprises one or more COO configurations of the CED.

In one or more example methods, the capability comprises one or more of: a capability of changing COO for a number K of beams, a capability of measuring phase and/or amplitude of dedicated resources, a relative position of the COO for each beam, a number of available COOs, one or more angles associated with one or more beams, a dimensionality of the CED, a position of the CED, an orientation of the CED, and whether there is a dependency between an input angle and an output angle.

In one or more example methods, performing S206 a channel measurement procedure comprises forming S206A the first beam having the first COO.

In one or more example methods, performing S206 a channel measurement procedure comprises forming S206B the second beam having the second COO.

In one or more example methods, performing S206 a channel measurement procedure comprises communicating S206C, via the first beam and the second beam, a first reference signal and a second reference signal respectively, for enabling measurement of a relative phase of the first reference signal and the second reference signal.

In one or more example methods, performing S206 a channel measurement procedure comprises obtaining S206D a first phase associated with the first beam and a second phase associated with the second beam. In other words, obtaining S206D a first phase and a second phase may comprise performing a first measurement of the first reference signal received via the first beam and performing a second measurement of the second reference signal received via the second beam.

In one or more example methods, performing S206 a channel measurement procedure comprises determining S206E a first phase difference between the first phase and the second phase. In one or more example methods, determining S206E a first phase difference may comprise obtaining measurement data associated with the first measurement and the second measurement.

In one or more example methods, performing S206 a channel measurement procedure comprises determining S206F based on the first phase difference and the first COO, the second COO, and/or a difference between the first COO and the second COO, the relative angle.

In one or more example methods, the method 200 comprises receiving S207, such as from the CED controlling node and/or the WD, a measurement report comprising the first phase and the second phase.

In one or more example methods, the method 200 comprises receiving S208, such as from the CED controlling node and/or the WD, a request for one or more parameters associated with the first beam and/or the second beam.

In one or more example methods, the method 200 comprises sending S210, such as to the CED controlling node and/or the WD, a report comprising an angle and/or a COO associated with a beam ID of one or more of the first beam and the second beam, and/or associated with a current beam. In one or more example methods, the method 200 comprises sending, such as to the CED controlling node and/or the WD, a report comprising one or more phase measurements, such as measurements of the first phase, the second phase, and/or the third phase.

In one or more example methods, the method 200 comprises sending S212, such as to the CED controlling node and/or the WD, a message comprising a relative angle and/or an absolute angle between the CED and the wireless device.

In one or more example methods, the method 200 comprises sending S214, such as to the CED controlling node and/or the WD, a message comprising a first reference phase of the first reference signal and a second reference phase of the second reference signal.

In one or more example methods, receiving S202 the first initiating message comprises receiving S202A instructions instructing the CED to apply a first phase pattern of the first beam to the second COO and to switch the first COO of the first beam to the second COO of the second beam.

In one or more example methods, performing S206 a channel measurement procedure comprises receiving S206G a third initiating message indicative of a third beam and using a third subset of a plurality of antenna elements of the CED having a third COO for enabling a third measurement of a third reference signal.

In one or more example methods, performing S206 a channel measurement procedure comprises forming S206H the third beam having the third COO.

In one or more example methods, performing S206 a channel measurement procedure comprises communicating S206I, via the third beam, the third reference signal for enabling measurement of a relative phase of the first reference signal and/or the second reference signal and the third reference signal.

In one or more example methods, receiving S206G the third initiating message comprises receiving S206G1 instructions instructing the CED to apply a first phase pattern of the first beam to the third COO and to switch the first COO of the first beam to the third COO of the third beam.

In one or more example methods, performing S206 a channel measurement procedure comprises obtaining S206J a third phase associated with the third beam. In one or more example methods, obtaining S206J a third phase may comprise performing a third measurement of the third reference signal received via the third beam.

In one or more example methods, performing S206 a channel measurement procedure comprises determining S206K a second phase difference between the first phase and the third phase. In one or more example methods, determining S206K a second phase difference may comprise obtaining measurement data associated with the first measurement and the third measurement.

In one or more example methods, wherein the second COO is different from the first COO.

FIGS. 4A-4B illustrate an example scenario in which the technique as disclosed herein is applied. FIG. 4A illustrates an example CED 800 as disclosed herein. The CED 800 in FIG. 4A comprises a single array of six times seven antenna elements. The CED 800 comprises a first subset 804A of antenna elements having a first COO which is associated with a first beam and a second subset 804B of antenna elements having a second COO which is associated with a second beam. The separation d, or distance, between the first COO and the second COO is λ/2. In other words, the COOs of the first beam and the second beam are shifted by λ/2 with respect to each other. An array separation of λ/2 will yield a phase offset of the beams being less than 2π(Pi). This may avoid ambiguity in the angle estimation.

FIG. 4B illustrates an example CED 800 as disclosed herein. The CED 800 in FIG. 4B comprises two arrays of six times six antenna elements each. The CED 800 comprises a first array comprising a first subset 806A of antenna elements having a first COO which is associated with a first beam and a second array comprising a second subset 806B of antenna elements having a second COO which is associated with a second beam. In this example, the first array and the second array are separated by λ/2. It may be appreciated that a linear uniform antenna array (ULA) with N patch antennas requires approximately N beams to cover an intended area. In other words, when increasing the separation between the COOs, the phase differences of the beams are larger. This may cause ambiguity but may on the other hand increase the performance of the angle estimation when the ambiguity can be resolved. It may be appreciated that the ambiguity may be resolved by using the fact that the beams point in specific directions. The ambiguity may be seen as several different possible positions of the WD. However, as the beam is pointing in a specific direction, the position closest to the direction of the beam may be chosen. The ambiguity may thereby be resolved. In this example, each beam, such as pencil beams, filters out 1/N:th part of the area or space. In other words, in this example the separation d, or distance, between the first COO and the second COO may be up to 3λ. In other words, in this example the COOs of the first beam and the second beam are shifted by 3λ with respect to each other. An array separation of 3λ may yield a phase offset of the beams being more than 2π (Pi).

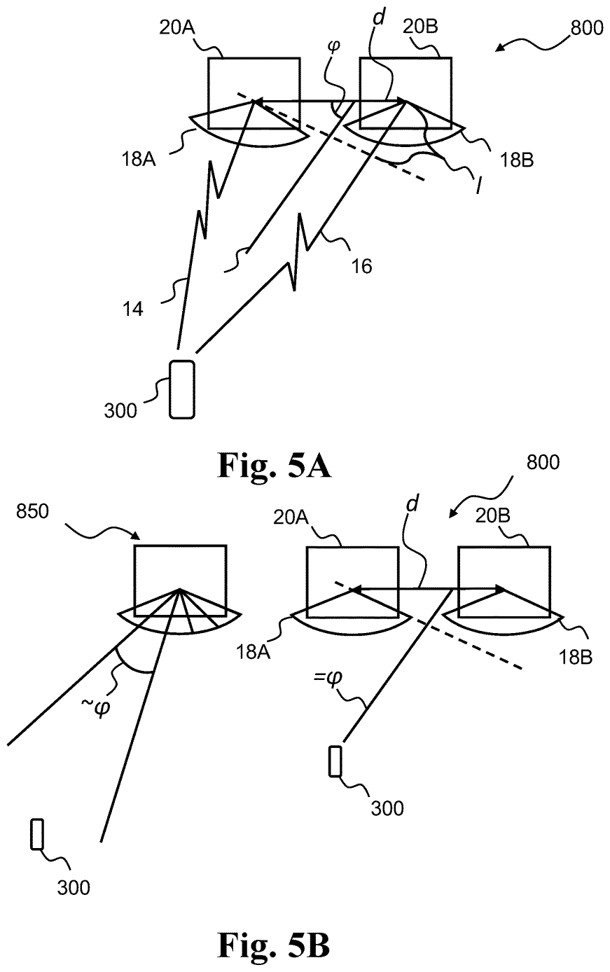

FIG. 5A is a diagram illustrating an example scenario where an example method according to this disclosure is applied. FIG. 5 shows a CED 800 configured to enable determination of a relative angle, such as angle φ, between the CED 800 and a wireless device 300. In this example, the CED is configured with a first subset 20A of antenna elements and a second subset 20B of antenna elements. The first subset 20A of antenna elements may form a first beam 18A with a first COO for enabling a first measurement of a first reference signal and the second subset 20B of antenna elements may form a second beam 18B with a second COO for enabling a second measurement of a second reference signal. The first COO and the second COO may be separated by a distance d. In one or more example methods, the first subset 20A and the second subset 20B of the CED are two separate antenna arrays. In one or more other examples, the first subset 20A and the second subset 20B are part of the same antenna array, but comprise different subsets of antennas. The dashed line in FIG. 5A-5B shows an example series of points (in space, along the propagation direction of the electro-magnetic wave) where the same phase measurement would be made, e.g., if a signal was transmitted from the WD 300. For example, the distance, I, between the second COO and the dashed line, indicates the extra distance that a signal has to travel from the WD 300, such as UE, to reach the second COO (or vice versa) and therefore results in a different phase measurement for the second COO compared to the phase measurement for the first COO.

In this example, the CED 800 is configured to perform, such as participate in, a channel measurement procedure for enabling determination of the relative angle, such as angle o, between the CED 800 and the wireless device 300, using the first beam 18A and the second beam 18B. In one or more example embodiments or examples, performing the channel measurement procedure comprises forming the first beam 18A having the first COO, forming the second beam 18B having the second COO, and communicating, via the first beam 18A and the second beam 18B, a first reference signal 14 and a second reference signal 16 respectively, for enabling measurement of a relative phase of the first reference signal 14 and the second reference signal 16.

FIG. 5B is a diagram illustrating an example scenario where an example method according to this disclosure is used (right side of FIG. 5B) in comparison to an angle estimation using a single beam with a single COO (left side of FIG. 5B).

In the example on the left side of FIG. 5B, an angle estimation using a single beam with a single COO is performed. In this example, the angle estimation may be performed based on an angle of the strongest beam at the network node, such as network node 850. In the example on the left side of FIG. 5B, the strongest beam may be selected after a beam sweep (as illustrated by the lines) and is limited in resolution by the width of the beam. With this technique, a full beam sweep may be required, which require multiple resources both for UL and DL. Furthermore, with this technique the accuracy of the angle determination is limited and may result in an angle range ~φ. Further, this technique may require a round trip time measurement to determine the distance to the WD, which also requires further resources.

In the example on the right side of FIG. 5B, an example method according to this disclosure is used to estimate (determine) an angle between the CED 800 and the WD 300. This example shows the same scenario as in FIG. 5A, where the angle o is determined. As illustrated, the present disclosure provides an improved accuracy of angle determination compared to the left side of FIG. 5B. The angle may be determined more precisely instead of determining an angle range limited by the beam width. Further, the present technique requires less resources. For example, for the UL-based angle estimation scenario, a single resource may be enough since the same reference signal may be received by both the first beam and the second beam. For example, for the DL-based angle estimation scenario, one resource per COO may allow to determine the angle.

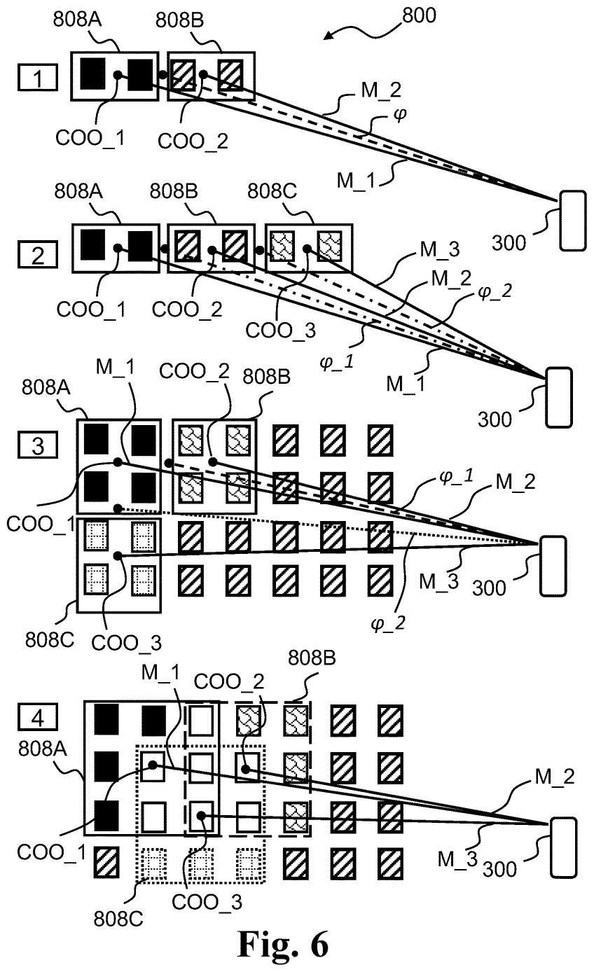

FIG. 6 is a diagram illustrating examples of different CED configurations according to this disclosure. FIG. 6 illustrates example scenarios where an example method according to this disclosure is applied using four different CED configurations (numbers 1-4). The different scenarios show CEDs 800 configured to enable determination of a relative angle between the CED 800 and a WD 300, such as an angle to a transmission point in the far field.

The first configuration 1 shows a CED 800 comprising a uniform linear array of four antenna elements. The CED in the first configuration is configured with a first subset 808A comprising two antenna elements and a second subset 808B comprising two antenna elements. The first subset 808A may form a first beam with a first COO, COO_1, for enabling a first measurement M_1 of a first reference signal and the second subset 808B may form a second beam with a second COO, COO_2, for enabling a second measurement M_2 of a second reference signal. In this example, the CED 800 is configured to perform, such as participate in, a channel measurement procedure for enabling determination of the relative angle φ, such as an azimuth angle, between the CED 800 and the wireless device 300, using the first beam and the second beam. As may be seen in the first configuration 1 one angle measurement is performed. In other words, words, in the first configuration 1 two measurements with different COOs have been performed to enable measurement of the angle o to the WD 300.

The second configuration 2 shows a CED 800 similar to the CED of the first configuration but comprising a uniform linear array of six antenna elements. The CED in the second configuration 2 is configured with third subset 808C comprising two antenna elements. The third subset 808C may form a third beam with a third COO, COO_3, for enabling a third measurement M_3 of a third reference signal. In this example, the CED 800 is configured to perform, such as participate in, a channel measurement procedure for enabling determination of the relative angle, such as an azimuth angle, between the CED 800 and the wireless device 300, using the first beam, the second beam, and the third beam. As may be seen in the second configuration 2 two angle measurements φ_1 and φ_2 are performed. In other words, words, in the second configuration 2 three measurements with different COOs have been performed to enable measurement of two angles φ_1 and _2 to the WD. It may be appreciated that the determination of two angles may allow the determination of a transmission point in the near field, NF, and optionally to determine, such as compute, a near field beamformer. For example, two angle measurements may allow to determine a cross point (such as focus point) of the two angles which may indicate a position (location) of the WD 300, such as distance to the WD 300 from the CED 800. In this example, the second configuration may allow the determination of both the angle between the CED 800 and the WD 300 and the distance from the CED to the WD.

The third configuration 3 shows a CED 800 similar to the CED of the first and the second configuration but comprising instead a uniform rectangular array of twenty eight antenna elements. The CED 800 in the third configuration 3 is configured with three subsets of antenna elements 808A, 808B, and 808C, each comprising four antenna elements and with COOs in the shape of a triangle with an orthogonal corner. As may be seen in the third configuration 3 two angle measurements φ_1 and φ_2 are performed, an azimuth angle φ_1 and an elevation angle φ_2. In other words, in the third configuration 3 three measurements M_1, M_2, and M_3 with different COOs, COO_1, COO_2, and COO_3, have been performed to enable measurement of two angles to the WD 300, an azimuth angle φ_1 and an elevation angle φ_2 to the WD in the far field. It may be appreciated that in this scenario, the two angle measurements would give a direction in 3D space, but not necessarily a position of the WD 300 since the intersection of the measurements would be a half-line in the direction of the WD 300, such as a proper direction in 3D space. In one or more example methods, the beam pattern is focused on a certain point (or a direction). This may imply that the likelihood of the WD 300 being at certain positions is not uniform over the intersection of the measurements. Therefore, the position may be resolved without ambiguity at high signal to noise ratio, SNR, as described earlier as well.

The fourth configuration 4 shows a CED 800 similar to the CED configuration of the third but comprising three subsets of antenna elements having COOs in the shape of a triangle without an orthogonal corner. The CED 800 in the fourth configuration 4 is configured with three subsets of antenna elements 808A, 808B, and 808C, each comprising nine antenna elements. As may be seen in the fourth configuration 4 two angle measurements are performed, an azimuth angle and an elevation angle. In other words, in the fourth configuration 4 three measurements M_1, M_2, and M_3 with different COOs, COO_1, COO_2, and COO_3, have been performed to enable measurement of two angles to the WD, an azimuth angle and an elevation angle to the WD in the far field. By having three subsets of antenna elements having COOs in the shape of a triangle without an orthogonal corner the two angle measurements may allow to determine a cross point (such as focus point) of the two angles which may indicate a position (location) of the WD 300, such as distance to the WD 300. In other words, in this example, the three lines on the drawing correspond to three angle measurements and not phase measurements. In this example, the fourth configuration 4 may allow the determination of the angle between the CED 800 and the WD 300, the elevation angle to the WD 300, and the distance from the CED 800 to the WD 300.

FIG. 7 shows a block diagram of an example CED controlling node 700 according to the disclosure. The CED controlling node 700 comprises memory circuitry 701, processor circuitry 702, and a wireless interface 703. The CED controlling node 700 may be configured to perform any of the methods disclosed in FIGS. 2A-2B. In other words, the CED controlling node 700 may be configured for controlling a CED.

The CED controlling node 700 is configured to communicate with a CED, such as the CED disclosed herein, using a wireless communication system.

The wireless interface 703 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M, millimeter-wave communications, such as millimeter-wave communications in licensed bands, such as device-to-device millimeter-wave communications in licensed bands, such as NTN and/or sidelink communication.

The CED controlling node 700 is configured to initiate, for example, via the wireless interface 703 and via the CED, a first measurement of a first reference signal received via a first beam of the CED, the first beam having a first center of origin, COO. The CED controlling node 700 is configured to initiate, for example, via the wireless interface 703 and via the CED, a second measurement of a second reference signal received via a second beam of the CED, the second beam having a second COO. The CED controlling node 700 is configured to obtain, for example, via the wireless interface 703 and/or from the CED and/or the WD, measurement data associated with the first measurement and the second measurement for enabling determination of a relative angle between the CED and the wireless device, WD.

Processor circuitry 702 is optionally configured to perform any of the operations disclosed in FIGS. 2A-2B (such as any one or more of S101, S102A, S102B, S104A, S104A1, S104B, S106, S106A, S106A1, S108A, S108B, S108C, S108D, S108E, S109, S110, S111, S112, S114). The operations of the CED controlling node 700 may be embodied in the form of executable logic routines (for example, lines of code, software programs, etc.) that are stored on a non-transitory computer readable medium (for example, memory circuitry 701) and are executed by processor circuitry 702.

Furthermore, the operations of the CED controlling node 700 may be considered a method that the CED controlling node 700 is configured to carry out and vice versa. Also, while the described functions and operations may be implemented in software, such functionality may also be carried out via dedicated hardware or firmware, or some combination of hardware, firmware and/or software.

Memory circuitry 701 may be one or more of a buffer, a flash memory, a hard drive, a removable media, a volatile memory, a non-volatile memory, a random access memory (RAM), or other suitable device. In a typical arrangement, memory circuitry 701 may include a non-volatile memory for long term data storage and a volatile memory that functions as system memory for processor circuitry 702. Memory circuitry 701 may exchange data with processor circuitry 702 over a data bus. Control lines and an address bus between memory circuitry 701 and processor circuitry 702 also may be present (not shown in FIG. 7). Memory circuitry 701 is considered a non-transitory computer readable medium.

Memory circuitry 701 may be configured to store measurements, configurations, measurement data, and capabilities of the CED in a part of the memory.

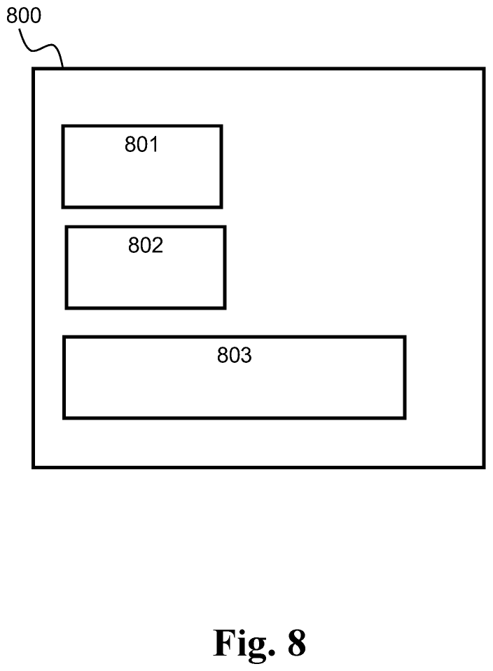

FIG. 8 shows a block diagram of an example CED 800 according to the disclosure. The CED 800 comprises memory circuitry 801, processor circuitry 802, and a wireless interface 803. The CED 800 may be configured to perform any of the methods disclosed in FIGS. 3A-3B.

The CED 800 is configured to communicate with a CED controlling node, such as the CED controlling node disclosed herein, using a wireless communication system.

The wireless interface 803 is configured for wireless communications via a wireless communication system, such as a 3GPP system, such as a 3GPP system supporting one or more of: New Radio, NR, Narrow-band IoT, NB-IOT, and Long Term Evolution-enhanced Machine Type Communication, LTE-M, millimeter-wave communications, such as millimeter-wave communications in licensed bands, such as device-to-device millimeter-wave communications in licensed bands, such as NTN and/or sidelink communication.

The CED 800 is configured to receive, for example, via the wireless interface 803, from the CED controlling node, a first initiating message indicative of a first beam and using a first subset of a plurality of antenna elements of the CED having a first COO for enabling a first measurement of a first reference signal. The CED 800 is configured to receive, for example, via the wireless interface 803, from the CED controlling node, a second initiating message indicative of a second beam and using a second subset of a plurality of antenna elements of the CED having a second COO for enabling a second measurement of a second reference signal. The CED 800 is configured to perform, for example, via the wireless interface 803 and/or using the processor circuitry 802, based on the first initiating message and the second initiating message, a channel measurement procedure for enabling determination of a relative angle between the CED and the WD, using the first beam and the second beam.

Processor circuitry 802 is optionally configured to perform any of the operations disclosed in FIGS. 3A-3B (such as any one or more of S201, S202A, S206A, S206B, S206C, S206D, S206E, S206F, S206G, S206G1, S206H, S206I, S206J, S206K, S207, S208, S210, S212, S214). The operations of the CED 800 may be embodied in the form of executable logic routines (for example, lines of code, software programs, etc.) that are stored on a non-transitory computer readable medium (for example, memory circuitry 801) and are executed by processor circuitry 802.

Furthermore, the operations of the CED 800 may be considered a method that the CED 800 is configured to carry out and vice versa. Also, while the described functions and operations may be implemented in software, such functionality may also be carried out via dedicated hardware or firmware, or some combination of hardware, firmware and/or software.

Memory circuitry 801 may be one or more of a buffer, a flash memory, a hard drive, a removable media, a volatile memory, a non-volatile memory, a random access memory (RAM), or other suitable device. In a typical arrangement, memory circuitry 801 may include a non-volatile memory for long term data storage and a volatile memory that functions as system memory for processor circuitry 802. Memory circuitry 801 may exchange data with processor circuitry 802 over a data bus. Control lines and an address bus between memory circuitry 801 and processor circuitry 802 also may be present (not shown in FIG. 8). Memory circuitry 801 is considered a non-transitory computer readable medium.

Memory circuitry 801 may be configured to store measurements, configurations, measurement data, and capabilities of the CED in a part of the memory in a part of the memory.

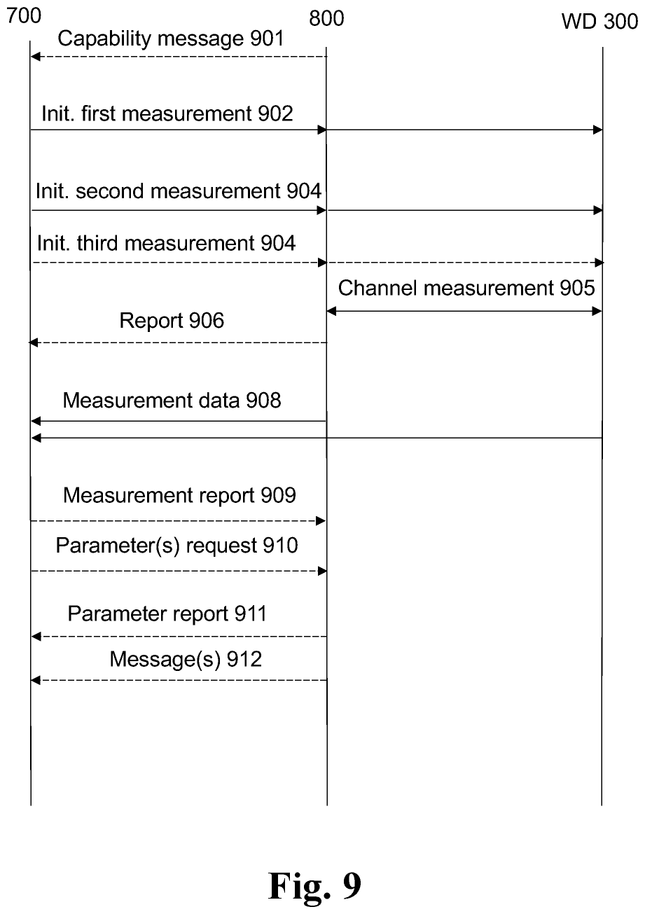

FIG. 9 shows a signaling diagram illustrating an example embodiment according to this disclosure. The signaling diagram involves a CED controlling node (CED CN), a CED 800, and a wireless device 300 (UE).

Optionally, the CED transmits (S201), to the CED CN 700, a capability message 901 indicative of a capability of the CED. Optionally, the capability of the CED may be pre-stored on the CED CN.

The CED CN 700 initiates (S102) a first measurement 902 of a first reference signal received via a first beam of the CED 800.

The CED 800 receives (S202) a first initiating message indicative of a first beam and using a first subset of a plurality of antenna elements of the CED 800 having a first COO for enabling a first measurement of a first reference signal.

The CED CN 700 may initiate the first measurement 902 by sending, to the CED 800, a first configuration for configuring the CED 800 with the first beam having the first COO.

The CED CN 700 may initiate the first measurement 902 by sending, to the wireless device 300, a first request message configuring the WD 300 to transmit and/or receive the first reference signal. The first request message may be seen as a request for a first channel sounding.

The CED CN 700 initiates (S104) a second measurement 904 of a second reference signal received via a second beam of the CED 800.

The CED 800 receives (S204) a second initiating message indicative of a second beam and using a second subset of a plurality of antenna elements of the CED 800 having a second COO for enabling a second measurement of a second reference signal.

The CED CN 700 may initiate the second measurement 904 by sending, to the CED 800, a second configuration for configuring the CED 800 with the second beam having the second COO.

The CED CN 700 may initiate the second measurement 904 by sending, to the wireless device 300, a second request message configuring the WD 300 to transmit and/or receive the second reference signal. The second request message may be seen as a request for a second channel sounding. Optionally, the CED CN 700 may send, to the CED 800, instructions instructing the CED 800 to apply a first phase pattern of the first beam to the second COO and wherein configuring the CED with the second beam comprises switching the first COO of the first beam to the second COO of the second beam.

Optionally, the CED CN 700 initiates (S106) a third measurement 904 of a third reference signal received via a third beam of the CED 800.

The CED CN 700 may initiate the third measurement 904 by sending, to the CED 800, a third configuration for configuring the CED 800 with the third beam having the third COO.

The CED CN 700 may initiate the third measurement 904 by sending, to the wireless device 300, a third request message configuring the WD 300 to transmit and/or receive the third reference signal. The third request message may be seen as a request for a third channel sounding.

Optionally, the CED CN 700 may send, to the CED 800, instructions instructing the CED 800 to apply a first phase pattern of the first beam to the third COO and wherein configuring the CED 800 with the third beam comprises switching the first COO of the first beam to the third COO of the third beam.

The CED performs (S206), based on the first initiating message and the second initiating message, a channel measurement procedure 905 for enabling determination of a relative angle between the CED 800 and the WD 300, using the first beam and the second beam.

Optionally, the CED CN 700 receives (S111), from the CED 800, a report 906 comprising an angle and/or a COO associated with a beam ID of one or more of the first beam and the second beam, and/or associated with a current beam.

The CED CN obtains (S108), such as from the CED 800 and/or the WD 300, measurement data associated with the first measurement and the second measurement for enabling determination of a relative angle between the CED 800 and the wireless device, WD 300.

Optionally, the CED CN 700 may obtain measurement data 908 by obtaining, such as from the CED 800 and/or the WD 300, a first phase associated with the first measurement and a second phase associated with the second measurement; and by determining a first phase difference between the first phase and the second phase. In other words, the CED 800 may send the measurements of the first phase and/or the second phase to the CED CN 700.

Optionally, the CED CN 700 may obtain measurement data 908 by determining, based on the first phase difference, the first COO, the second COO, and/or a difference between the first COO and the second COO, the relative angle.

Optionally, the CED CN 700 may obtain measurement data 908 byobtaining, such as from the CED 800 and/or the WD 300, a third phase associated with the third measurement; and by determining a second phase difference between the first phase and the third phase.

Optionally, the CED CN 700 may send (S109), to the CED 800, a measurement report 909 comprising the first phase and the second phase.

Optionally, the CED CN 700 may request (S110), from the CED 800, one or more parameters, such as a parameter report 911, associated with the first beam and/or the second beam.

Optionally, the CED CN 700 may obtain (S112), from the CED 800, a message 912 comprising a relative angle and/or an absolute angle between the CED and the wireless device.

Optionally, the CED CN 700 may obtain (S114), from the CED 800, a message 912 comprising a first reference phase of the first reference signal and a second reference phase of the second reference signal.

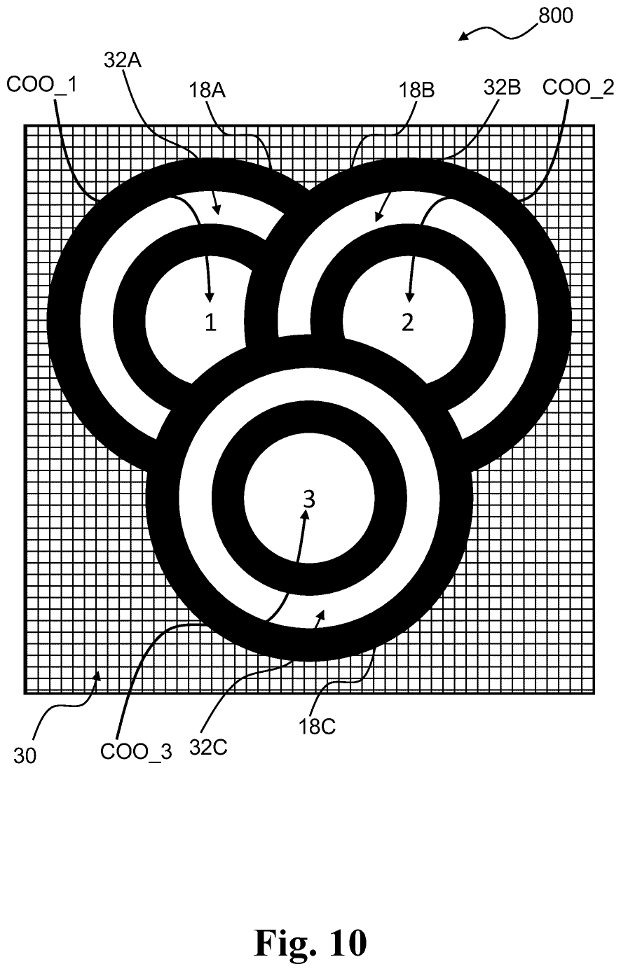

FIG. 10 is a diagram illustrating an example CED according to this disclosure. In this example, the CED 800 is configured with a first beam 18A having a first COO, COO_1. The first beam 18A may comprise a first phase pattern 32A around the first COO_1, such as defining the first COO_1. In other words, the scattering field may have a wider beam by using defined phase pattern around the phase center, such as COO. In this example, the defined phase pattern is a circular phase pattern. The CED 800 may be configured to apply the first phase pattern 32A of the first beam 18A to the second COO, COO_2, such as to form a second phase pattern 32B, and to switch the first COO_1 of the first beam 18A to the second COO_2 of the second beam 18B. The first phase pattern 32A of the first beam 18A may be formed by a regular phase pattern having a pre-defined phase center location as the first COO_1. Applying a first phase pattern 32A of the first beam 18A to the second COO_2 and switching the first COO_1 of the first beam 18A to the second COO_2 of the second beam 18B may be seen as copying a phase code book of the first beam 18A and then shifting the first COO_1 in a x1- and/or y1-direction with an X1 distance and/or an Y1 distance from the first COO_1, thereby applying a similar phase pattern as the first phase pattern 32A in a new phase center, namely the second COO, such as to form the second phase pattern 32B.

The CED 800 may be configured to apply the first phase pattern 32A of the first beam 18A to the third COO, COO_3, such as to form a third phase pattern 32C, and to switch the first COO_1 of the first beam 18A to the third COO_3 of the third beam 18C. The first phase pattern 32A of the first beam 18A may be formed by a regular phase pattern having a pre-defined phase center location as the first COO_1. Applying a first phase pattern 32A of the first beam 18A to the third COO_3 and switching the first COO_1 of the first beam 18A to the third COO 3 of the third beam 18C may be seen as copying a phase code book of the first beam 18A and then shifting the first COO_1 in a x2- and/or y2-direction with an X2 distance and/or an Y2 distance from the first COO_1, thereby applying a similar phase pattern as the first phase pattern 32A in a new phase center, namely the third COO, such as to form the third phase pattern 32C. In one or more example methods, three states with three different phase center locations, such as COOs, have been formed. In other words, three beams, namely the first beam 18A, the second beam 18B, and the third beam 18C having each a different COO, namely the first COO_1, the second COO_2, and the third COO_3 have been formed.

In this example, the area 30 around the three beams may have a random phase and/or a specific pattern. In this example, the CED 800 may be an RIS. It may be appreciated that this technique may mimic having different antenna arrays having different COOs, but only having one antenna array.

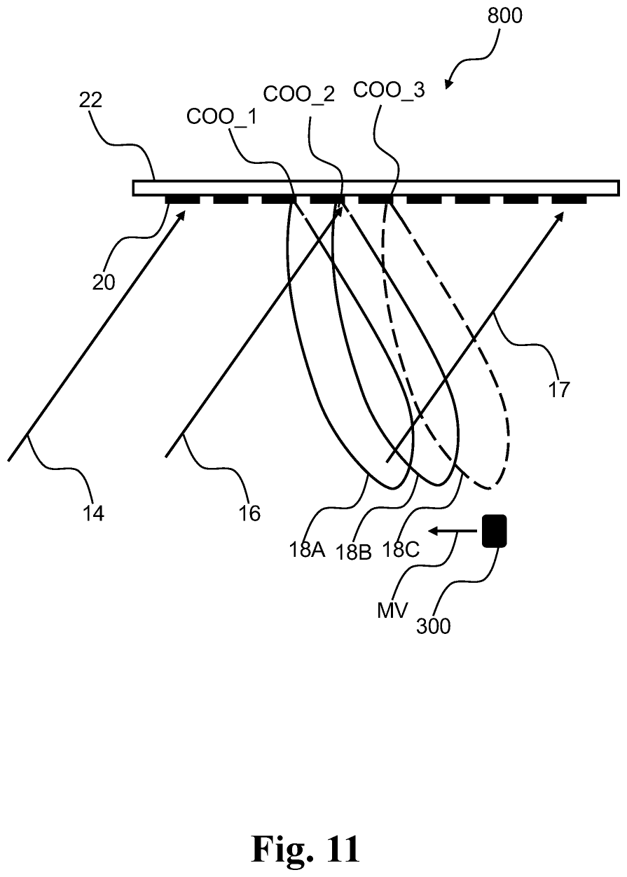

FIG. 11 is a diagram illustrating an example scenario where an example method according to this disclosure is applied. FIG. 11 shows an example where the CED 800 of FIG. 10 is used for enabling determination of an angle between the CED 800 and the WD 300.

In this example, the CED 800 is configured to perform, such as participate in, a channel measurement procedure for enabling determination of the relative angle between the CED 800 and the wireless device 300, using the first beam 18A, the second beam 18B, and optionally the third beam 18C. In one or more example embodiments or examples, performing the channel measurement procedure comprises forming the first beam 18A having the first COO, forming the second beam 18B having the second COO, and communicating, via the first beam 18A and the second beam 18B, a first reference signal 14 and a second reference signal 16 respectively, for enabling measurement of a relative phase of the first reference signal 14 and the second reference signal 16. In one or more example embodiments or examples, performing the channel measurement procedure comprises forming the third beam 18C having the third COO and communicating, via the third beam 18C a third reference signal 17 for enabling measurement of a relative phase of the third reference signal 17. The CED 800 may comprise an antenna panel 22 comprising a plurality of antenna elements 20.

It may be appreciated that by using these three states, three measurements of reference signals can be initiated for determining a location of the WD, such as WD 300, and/or for determining a moving vector MV associated with the WD 300.

Examples of methods and products (CED controlling node and CED) according to the disclosure are set out in the following items:
Item 1. A method (100) performed in a coverage enhancing device, CED, controlling node for enabling determination of a relative angle between a coverage enhancing device, CED, and a wireless device, the method comprising:
   initiating (S102) a first measurement of a first reference signal received via a first beam of the CED, the first beam having a first center of origin, COO;
   initiating (S104) a second measurement of a second reference signal received via a second beam of the CED, the second beam having a second COO; and
   obtaining (S108) measurement data associated with the first measurement and the second measurement for enabling determination of a relative angle between the coverage enhancing device, CED, and the wireless device, WD.
Item 2. The method according to item 1, wherein initiating (S102) the first measurement comprises:
   sending (S102A), to the CED, a first configuration for configuring the CED with the first beam having the first COO.
Item 3. The method according to any of the previous items, wherein initiating (S102) the first measurement comprises:
   sending (S102B), to the wireless device, a first request message configuring the WD to transmit and/or receive the first reference signal.
Item 4. The method according to any of the previous items, wherein initiating (S104) the second measurement comprises:
   sending (S104A), to the CED, a second configuration configuring the CED with the second beam having the second COO.
Item 5. The method according to item 4, wherein initiating (S104) the second measurement comprises:
   sending (S104B), to the wireless device, a second request message configuring the WD to transmit and/or receive the second reference signal.
Item 6. The method according to any of the previous items, wherein the method (100) comprises:
   receiving (S101), from the CED, a capability message indicative of a capability of the CED, wherein the capability comprises one or more COO configurations of the CED.
Item 7. The method according to item 6, wherein the capability comprises one or more of: a capability of changing COO for a number K of beams, a capability of measuring phase and/or amplitude of dedicated resources, a relative position of the COO for each beam, a number of available COOs, one or more angles associated with one or more beams, a dimensionality of the CED, a position of the CED, an orientation of the CED, and whether there is a dependency between an input angle and an output angle.
Item 8. The method according to any of the previous items, wherein obtaining (S108) measurement data comprises:
   obtaining (S108A) a first phase associated with the first measurement and a second phase associated with the second measurement; and
   determining (S108B) a first phase difference between the first phase and the second phase.
Item 9. The method according to item 8, the method (100) comprising:
   sending (S109), to the CED, a measurement report comprising the first phase and the second phase.
Item 10. The method according to any of items 8-9, wherein obtaining (S108) measurement data comprises determining (S108C), based on the first phase difference and the first COO, the second COO, and/or a difference between the first COO and the second COO, the relative angle.
Item 11. The method according to any of the previous items, the method (100) comprising:
   requesting (S110), from the CED, one or more parameters associated with the first beam and/or the second beam.
Item 12. The method according to any of the previous items, the method (100) comprising:
   receiving (S111), from the CED, a report comprising an angle and/or a COO associated with a beam ID of one or more of the first beam and the second beam, and/or associated with a current beam.
Item 13. The method according to any of the previous items, the method (100) comprising:
   obtaining (S112), from the CED, a message comprising a relative angle and/or an absolute angle between the CED and the wireless device.
Item 14. The method according to any of the previous items, the method (100) comprising:
   obtaining (S114), from the CED, a message comprising a first reference phase of the first reference signal and a second reference phase of the second reference signal.
Item 15. The method according to any of items 4-14, wherein sending (S104A) the second configuration comprises sending (S104A1) instructions instructing the CED to apply a first phase pattern of the first beam to the second COO and wherein configuring the CED with the second beam comprises switching the first COO of the first beam to the second COO of the second beam.
Item 16. The method according to any of the previous items, the method (100) comprising:
   initiating (S106) a third measurement of a third reference signal received via a third beam of the CED, the third beam having a third COO;
   wherein initiating (S106) a third measurement comprises sending (S106A), to the CED, a third configuration configuring the CED with the third beam having the third COO; and
   wherein sending (S106A) the third configuration comprises sending (S106A1) instructions instructing the CED to apply a first phase pattern of the first beam to the third COO and wherein configuring the CED with the third beam comprises switching the first COO of the first beam to the third COO of the third beam.
Item 17. The method according to item 16, wherein obtaining (S108) measurement data comprises:
   obtaining (S108D) a third phase associated with the third measurement; and
   determining (S108E) a second phase difference between the first phase and the third phase.
Item 18. The method according to any of the previous items, wherein the second COO is different from the first COO.
Item 19. A method (200) performed in a coverage enhancing device, CED, for enabling determination of a relative angle between the coverage enhancing device and a wireless device, the method comprising:
   receiving (S202) a first initiating message indicative of a first beam and using a first subset of a plurality of antenna elements of the CED having a first COO for enabling a first measurement of a first reference signal;
   receiving (S204) a second initiating message indicative of a second beam and using a second subset of a plurality of antenna elements of the CED having a second COO for enabling a second measurement of a second reference signal; and
   performing (S206), based on the first initiating message and the second initiating message, a channel measurement procedure for enabling determination of a relative angle between the CED and the WD, using the first beam and the second beam.
Item 20. the method according to item 19, wherein the method (200) comprises:
   sending (S201), to a CED controlling node, a capability message indicative of a capability of the CED, wherein the capability comprises one or more COO configurations of the CED.
Item 21. The method according to item 20, wherein the capability comprises one or more of: a capability of changing COO for a number K of beams, a capability of measuring phase and/or amplitude of dedicated resources, a relative position of the COO for each beam, a number of available COOs, one or more angles associated with one or more beams, a dimensionality of the CED, a position of the CED, an orientation of the CED, and whether there is a dependency between an input angle and an output angle.
Item 22. The method according to any of items 19-21, wherein performing (S206) a channel measurement procedure comprises:
   forming (S206A) the first beam having the first COO;
   forming (S206B) the second beam having the second COO; and
   communicating (S206C), via the first beam and the second beam, a first reference signal and a second reference signal respectively, for enabling measurement of a relative phase of the first reference signal and the second reference signal.
Item 23. The method according to item 22, wherein performing (S206) a channel measurement procedure comprises:
   obtaining (S206D) a first phase associated with the first beam and a second phase associated with the second beam; and
   determining (S206E) a first phase difference between the first phase and the second phase.
Item 24. The method according to item 23, the method (200) comprising:
   receiving (S207) a measurement report comprising the first phase and the second phase.
Item 25. The method according to any of items 23-24, wherein performing (S206) a channel measurement procedure comprises:
   determining (S206F) based on the first phase difference and the first COO, the second COO, and/or a difference between the first COO and the second COO, the relative angle.
Item 26. The method according to any of items 19-25, the method (200) comprising:
   receiving (S208) a request for one or more parameters associated with the first beam and/or the second beam.
Item 27. the method according to any of items 22-26, the method (200) comprising:
   sending (S210) a report comprising an angle and/or a COO associated with a beam ID of one or more of the first beam and the second beam, and/or associated with a current beam.
Item 28. The method according to any of items 19-27, the method (200) comprising:

sending (S212) a message comprising a relative angle and/or an absolute angle between the CED and the wireless device.
Item 29. The method according to any of items 19-28, the method (200) comprising:
   sending (S214) a message comprising a first reference phase of the first reference signal and a second reference phase of the second reference signal.
Item 30. The method according to any of items 19-29, wherein receiving (S202) the first initiating message comprises receiving (S202A) instructions instructing the CED to apply a first phase pattern of the first beam to the second COO and to switch the first COO of the first beam to the second COO of the second beam.
Item 31. The method according to any of items 19-30, wherein performing (S206) a channel measurement procedure comprises:
   receiving (S206G) a third initiating message indicative of a third beam and using a third subset of a plurality of antenna elements of the CED having a third COO for enabling a third measurement of a third reference signal;
   forming (S206H) the third beam having the third COO; and
   communicating (S206I), via the third beam, the third reference signal for enabling measurement of a relative phase of the first reference signal and/or the second reference signal and the third reference signal.
Item 32. The method according to item 31, wherein receiving (S206G) the third initiating message comprises receiving (S206G1) instructions instructing the CED to apply a first phase pattern of the first beam to the third COO and to switch the first COO of the first beam to the third COO of the third beam.
Item 33. The method according to any of items 31-32, wherein performing (S206) a channel measurement procedure comprises:
   obtaining (S206J) a third phase associated with the third beam; and
   determining (S206K) a second phase difference between the first phase and the third phase.
Item 34. the method according to any of items 19-33, wherein the second COO is different from the first COO.
Item 35. A coverage enhancing device, CED, controlling node (700) comprising memory circuitry (701), processor circuitry (702), and a wireless interface (703), wherein the CED controlling node is configured to perform any of the methods according to any of Items 1-18.
Item 36. A coverage enhancing device, CED, (800) comprising memory circuitry (801), processor circuitry (802), and a wireless interface (803), wherein the CED (800) is configured to perform any of the methods according to any of Items 19-34.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc.

does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-11 comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method performed in a coverage enhancing device (CED) controlling node for enabling determination of a relative angle between the CED and a wireless device, the method comprising:
initiating a first measurement of a first reference signal received via a first beam of the CED, the first beam having a first center of origin (COO);
initiating a second measurement of a second reference signal received via a second beam of the CED, the second beam having a second COO; and
obtaining measurement data associated with the first measurement and the second measurement for enabling determination of a relative angle between the CED and the wireless device (WD).

2. The method according to claim 1, wherein initiating the first measurement comprises:
sending, to the CED, a first configuration for configuring the CED with the first beam having the first COO.

3. The method according to claim 1, wherein initiating the first measurement comprises:
sending, to the wireless device, a first request message configuring the WD to transmit and/or receive the first reference signal.

4. The method according to claim 1, wherein initiating the second measurement comprises:
sending, to the CED, a second configuration configuring the CED with the second beam having the second COO; and
sending, to the wireless device, a second request message configuring the WD to transmit and/or receive the second reference signal.

5. The method according to claim 1, previous claims, wherein the method comprises:
receiving, from the CED, a capability message indicative of a capability of the CED, wherein the capability comprises one or more COO configurations of the CED.

6. The method according to claim 1, previous claims, wherein the method comprises:
receiving, from the CED, a capability message indicative of a capability of the CED, wherein the capability comprises one or more COO configurations of the CED.

7. The method according to claim 6, wherein the capability comprises one or more of: a capability of changing COO for a number K of beams, a capability of measuring phase and/or amplitude of dedicated resources, a relative position of the COO for each beam, a number of available COOs, one or more angles associated with one or more beams, a dimensionality of the CED, a position of the CED, an orientation of the CED, and whether there is a dependency between an input angle and an output angle.

8. The method according to claim 1, wherein obtaining measurement data comprises:
obtaining a first phase associated with the first measurement and a second phase associated with the second measurement; and
determining a first phase difference between the first phase and the second phase.

9. The method according to claim 8, the method comprising:
sending, to the CED, a measurement report comprising the first phase and the second phase.

10. The method according to claim 8, wherein obtaining measurement data comprises determining, based on the first phase difference and the first COO, the second COO, and/or a difference between the first COO and the second COO, the relative angle.

11. The method according to claim 1, the method comprising:
requesting, from the CED, one or more parameters associated with the first beam and/or the second beam.

12. The method according to claim 1, the method comprising:
receiving, from the CED, a report comprising an angle and/or a COO associated with a beam ID of one or more of the first beam and the second beam, and/or associated with a current beam.

13. The method according to claim 1, the method comprising:
obtaining, from the CED, a message comprising a relative angle and/or an absolute angle between the CED and the wireless device.

14. The method according to claim 1, the method comprising:
obtaining, from the CED, a message comprising a first reference phase of the first reference signal and a second reference phase of the second reference signal.

15. The method according to claim 4, 14, wherein sending the second configuration comprises sending instructions instructing the CED to apply a first phase pattern of the first beam to the second COO and wherein configuring the CED with the second beam comprises switching the first COO of the first beam to the second COO of the second beam.

16. The method according to claim 1, the method comprising:
initiating a third measurement of a third reference signal received via a third beam of the CED, the third beam having a third COO;
wherein initiating a third measurement comprises sending, to the CED, a third configuration configuring the CED with the third beam having the third COO; and
wherein sending the third configuration comprises sending instructions instructing the CED to apply a first phase pattern of the first beam to the third COO and wherein configuring the CED with the third beam comprises switching the first COO of the first beam to the third COO of the third beam.

17. The method according to claim 16, wherein obtaining measurement data comprises:
obtaining a third phase associated with the third measurement; and
determining a second phase difference between the first phase and the third phase.

18. The method according to claim 1, wherein the second COO is different from the first COO.

19. A method performed in a coverage enhancing device (CED) for enabling determination of a relative angle between the coverage enhancing device and a wireless device, the method comprising:
receiving a first initiating message indicative of a first beam and using a first subset of a plurality of antenna elements of the CED having a first COO for enabling a first measurement of a first reference signal;
receiving a second initiating message indicative of a second beam and using a second subset of a plurality of antenna elements of the CED having a second COO for enabling a second measurement of a second reference signal; and
performing, based on the first initiating message and the second initiating message, a channel measurement procedure for enabling determination of a relative angle between the CED and the WD, using the first beam and the second beam.

20. The method according to claim 19, wherein the method comprises:
sending, to a CED controlling node, a capability message indicative of a capability of the CED, wherein the capability comprises one or more COO configurations of the CED.

21-36. (canceled)
